(19) United States
(12) Patent Application Publication
(10) Pub. No.: US 2006/0153551 A1
(43) Pub. Date: Jul. 13, 2006

(54) Air/water heat exchanger with partial water ways

(76) Inventor: Heinz Schilling, Kempen (DE)

Correspondence Address: Joseph A Calvaruso;Chadbourne & Parke, 30 Rockefeller Plaza, New York, NY, 10112, US

(21) Appl. No.: 10/543,664

(22) PCT Filed: Dec. 30, 2003
(86) PCT No.: PCT/EP03/14954

§ 371 Date: Feb. 28, 2006

(30) Foreign Application Priority Data
Jan. 31, 2003 (DE) 103 04 077.3

(51) Int. Cl. F24H 1/10; H05B 3/78

(52) U.S. Cl. 392/492

(57) ABSTRACT

The invention relates to counterflow layered heat exchanger for exchanging heat between gaseous and liquid media that is provided with a modular or module block design. A module area has, between two airflow areas (2), a water flow area (3) with water flow channels (5) that, from the air inlet to the air outlet, are located in a plane. The water way, in particular, can be divided/is divided into a number of parallel partial water ways by the heat exchanger in at least one section/area (A1, A2) by interconnecting a number of parallel water flow channels (5). This is done, in particular, to set a desired or required water value ratio. The invention also relates to a method for operating a heat exchanger.

### FIELD OF THE INVENTION

The invention relates to a heat exchanger, especially a countercurrent laminar heat exchanger between gaseous and liquid media, preferably constructed in modular or block modular design, as well as a process for the operation of a heat exchanger.

### BACKGROUND OF THE INVENTION

Such heat exchangers are used to transfer heat volumes and their temperature potentials from one heat carrier medium to another heat carrier medium, wherein the one medium is preferably a gas and especially air, and the other a liquid fluid, preferably water or even water-antifreeze blends and/or other suitable liquid fluids. A typical air-to-water glycol heat exchanger finds frequent use.

The construction of such heat exchangers for the transfer of heat between a gaseous and a liquid medium is subject to structural constraints due to the very high differential between the flow volumes on the gas side and the fluid side resulting from the greatly different heat capacities of different media and from the fact that for an efficient transfer of heat, especially for the recovery techniques, the heat capacity flows of the two utilized media should be identical.

The ratio of heat capacity flows, for example in an air-to-water heat exchanger, is represented by the so-called water equivalent ratio. Without the condensate precipitation the water equivalent ratio w=mAir×cAir/mWater×cWater should ideally be equal to 1 to permit the most efficient transfer of heat and temperature potential. In the equation m denotes mass and c the specific heat capacity of the corresponding medium. With the condensate precipitate, the controlling factor is the enthalpy differential in lieu of cAir.

Because of the very great differences in the specific heat capacities, there arises in the specific case of an air-to-water heat exchanger a difference in the flow volume on the order of one volume share of water per unit of time to approx 3,400 volume shares of air per unit of time.

Often, in the construction of heat exchangers to client's specifications, the client will specify the airflow volume and external dimensions of a heat exchanger module, making it necessary to calculate and convert the corresponding volume of water flow. This may result, especially where airflow volumes are limited, and in the construction of a heat exchanger with the customary water pipe cross-sections of, for example 8 to 15 mm inner diameter, that for the required water-flow volume the flow velocity may prove inadequate, so that the heat transfer resistance at the inner sides of the tubes is raised, thereby greatly limiting the heat transfer.

The diminished heat transfer in the presence of limited flow velocities results from the fact that in limited flow velocities inside the water tube a laminar flow with a roughly parabolic flow velocity profile develops, whereby the flow velocity of water is at its lowest on the interior side of the tube, which creates an insulating cushion preventing further efficient transfer of heat.

For this reason, to fill a particular customer specification for a heat exchanger design, it is necessary to match, individually, the customer's structural specifications in order to preset the water equivalent ratio to the optimal value and achieve a sufficiently high water-flow velocity.

As to the prior art, it is known for example that in German patent DE 33 25 230 provision is made for packing material to be inserted within the liquid-carrying tubes so as to artificially reduce the effective tube cross-section and thereby augment the flow velocity of the liquid medium while retaining a constant flow volume. Nevertheless, the insertion of such packing material into the tubes of a heat exchanger is structurally very costly, in addition to which it entails the risk that impurities will collect on the packing material, leading to a blockage and ultimately a breakdown of the heat exchanger.

It is further known from the cited patent that an optimal water equivalent ratio may be attained by a link-up adjusted in height. This, however, will result in higher airflow resistance in the direction of the airflow on account of the transverse positioning of the tubes.

### SUMMARY OF THE INVENTION

The task of the invention is to make available a universal heat exchanger, especially a modular one, by which to attain in a structurally simple manner the requisite ratio of heat capacity flows, an adequate flow velocity of the fluid medium inside the media-carrying pipes as well as elevated efficiency and ease of cleaning.

According to the invention, this task is solved in that a heat exchanger, or in the case of a modular structure, the modular section of a heat exchanger, features between two airflow regions a water-flow region with water-flow channels, preferably arranged on one level from air inlet to air outlet.

The very fact of the subdivision into airflow regions and water-flow regions signifies that no provision is made for tubes within the airflow regions so that within such regions air may flow freely through the heat exchanger. Thanks to the preferred arrangement within the water-flow region, with water-flow channels located on one level, in particular all running in parallel the one after the other especially in the direction of the airflow, preferably arranged as tight as technically feasible, the airflow resistance diminishes, in that essentially the airflow impacts only the first water-flow channel in the direction of the airflow, whereby the gap between two adjoining flow channels is preferably smaller than half the width, that is half the diameter of a flow channel.

Moreover, in this structure, the waterway through the heat exchanger is preferably divisible or subdivided into several parallel divided waterways in at least one segment/area by bundling together several (but at least two) parallel water-flow channels.

With a heat exchanger constructed in this fashion there is also the possibility of presetting in a simple manner the desired or specified water equivalent ratio and/or generally speaking the heat capacity flow ratio, especially while attaining an adequate flow velocity within the water-flow channels. Beyond that, by arranging the water-flow channels on one level, there is the added advantage that the heat exchanger can be very simply ventilated and discharged without additional devices.

With this construction of heat exchangers it is possible to make available standardized heat exchanger modules matching individually the required water-flow volumes depending on the requisite air impact surface and/or the corresponding airflow volume, with adequate or sufficiently high flow velocity, without the need for costly structural alterations or new construction of such a heat exchanger module.

According to the invention, the essential concept of this construction stems from the fact that the invented heat exchanger features several water-flow channels arranged next to and especially parallel to each other, channeling the water on the principle of cross-current countercurrent, especially on one level through the heat exchanger. According to the countercurrent principle, the waterway through the heat exchanger runs from the air outlet of a heat exchanger to the air inlet, whereby the water-flow channels run transverse to the direction of the air and accordingly the waterway and/or the water running counter to the airflow, at the same time repeatedly cross the airflow thereby generating the so-called cross counter-current principle.

Now, if several water-flow channels crossing the airflow are bundled parallel together in at least one segment/area of the heat exchanger, then by this consolidation the waterway can be subdivided into several parallel divided waterways, whereby every divided waterway leads through a water-flow channel. In this way, the effective cross-section of the waterway inside the heat exchanger can be enlarged, for the reason that the effective cross-section of the waterway is equivalent to the sum of the cross-sections of the individual divided waterways or water-flow channels.

Thus for example if each water-flow channel possesses the same cross-section (in the case of circular tubes, the same diameter), it is possible for example in bundling together two parallel water-flow channels, and thereby subdividing the waterway into two parallel divided waterways crossing the airflow, to double the effective cross-section of the waterway compared to a single water-flow channel. The same is true in bundling together even a larger number of water-flow channels.

The bundling together of water-flow channels takes place in such a way that in at least two bundled water-flow channels arranged parallel next to each other, the water flows in the same direction, crossing the stream of air.

This type of construction yields universally usable heat exchangers, since for example in small modular heat exchangers with a limited airflow volume and the associated limited water-flow volume, it is possible to dispense with bundling of water-flow channels and/or the subdivision of the waterway into several divided waterways, or limit the bundling to just a few flow channels, to ensure sufficiently high flow velocities through each water-flow channel.

Conversely, if the air cross-section is for example substantially enlarged, with its concomitant change of the water-flow volume in order to preserve the water equivalent ratio, it is possible to bundle together several water-flow channels in parallel into a technically combined waterway or if the waterway is subdivided through the heat exchanger in at least one section, into several divided waterways in order to take advantage of a larger volume of water per unit of time, without thereby augmenting the flow velocity of the water within the bundled divided waterways.

With such an embodiment of the invention, it is therefore possible to match for a predetermined air impact surface of a heat exchanger and/or, with a constant heat exchanger height, for a predetermined width of the heat exchanger, the requisite volume of water flowing through the heat exchanger per unit of time, by subdividing the waterway into several parallel divided waterways, and/or flow channels, especially arranged the one after the other on one level. Conversely, by choosing the lowest possible divided water quantities in a flow channel and by possible bundling of flow channels, any desired air volume-to-module and/or module width or module surface may be achieved.

Based on the fact that by subdividing the waterway into several parallel flow channels the cross-sectional surface of each water-flow channel may be reduced, this further results, in the direction of the airflow, in a smaller flow impact area of the water-flow channels lying transverse to the direction of the airflow, so that by this arrangement of as many as possible water-flow channels lying the one behind the other, a reduced airflow resistance of the heat exchanger is achieved in operation. Accordingly, this construction makes it possible to produce highly efficient heat exchangers.

In a first embodiment, a modular heat exchanger may be constructed in such a way that the airflow and the water-flow areas are created as separate production units from separate air and water-flow units. In this manner a heat exchanger according to the invention may be built up by connecting two airflow units with an in-between water-flow unit, paying attention to an adequate transfer of heat. The requisite heat transfer may be ensured by every possible thermally appropriate connection method, as for example by welding together, soldering, cementing, compressing, grinding etc. of the individual production units.

Particularly preferred is the construction of the water-flow area in the form of a heat conducting plate with water-flow channels incorporated therein. The smaller the cross-section of the water-flow channels chosen for this heat conducting plate, the thinner the heat conducting plate and the lower its airflow resistance in the direction of the airflow.

Such a heat conducting plate may be constructed in different ways. As a first alternative, the heat conducting plate may be constructed of solid material featuring several water-flow channels arranged in parallel next to each other, formed by perforations or channels otherwise created within the thickness of the solid material.

In a second preferred alternative embodiment, the heat conducting plate may be constructed of several interconnected rectangular tubes arranged in parallel next to each other. Preferably, several parallel flow channels may be formed within the rectangular tubes, creating all together a waterway. Such rectangular tubes may be joined for example by cementing, welding, soldering, tongue and groove etc., thereby creating when placed next to each other a heat conducting plate featuring a height matching the height of each individual rectangular tube.

Preferably, the individual rectangular tubes exhibit the same structural height, so as to construct ultimately a heat conducting plate with two flat surfaces whereon to assemble the airflow units. Preferably, the rectangular tubes, while of the same height, may feature different widths and by the same token cross-sections, whereby depending on the width, the tubes may feature a different number of flow channels situated therein.

In a further third alternative embodiment, provision may be made for the heat conducting plate to be constructed of two interconnectible or interconnected dividing plates shaped in such a way that when joined, they form water-flow channels between them.

Thus, for example, provision may be made for the dividing plates to feature flanges making up opposite inner walls of the channels, so as to form the water-flow channels when the two dividing plates are joined. Similarly, the dividing plates may be fashioned as plates with punched-in recesses which again form channels as the individual plates are joined. There are a variety of different construction methods conceivable for the structural make-up of the heat conducting plates.

The invention described herein is not limited to the three aforesaid alternatives and preferred structural possibilities. It is within the expert's choice to construct a suitable heat conducting plate featuring several parallel water-flow channels arranged next to each other and interconnectible or interconnected in such a way as to secure the desired subdivision of the waterway into several dividing waterways.

By constructing the water-flow region in the form of the previously described conducting plates, when the air and water flow units are interconnected, there is automatically obtained a separation between the two airflow units, so that the air streaming into one airflow unit cannot overflow into another airflow unit. Structurally, such an overflow is prevented by the self-sealing construction of the heat conducting plate, so that in effect self-sealing airflow channels are created in the airflow units which may be for example constructed of several plates.

As compared to the customary structures in which merely the adjoining heat exchanger plates are traversed by tubes running transverse to the direction of the air flow, the construction proposed here ensures a distinctly lower loss of pressure on the air side since the air can flow unimpeded through the airflow channels so built, without impacting the transversely running tubes. Thanks to this lower loss of pressure compared to conventional heat exchangers operating on the cross-countercurrent principle, the operation of such heat exchangers is distinctly more economical and energy-saving.

A further advantage of this construction lies in the fact that possible depositions of soil within the airflow units may be simply eliminated from the individual airflow channels, since a stream of air fed in for cleaning purposes, for example by a high-pressure blower or even a steam-cleaning jet, stays channeled within the airflow channel and cannot escape into adjoining regions. Accordingly, a stream of air fed at the inlet of a heat exchanger will definitively exit at the corresponding outlet of the heat exchanger, not being able to change the direction of its flow.

Accordingly, compared to the state of the art, the construction described here affords special cleaning facility and outstanding energy efficiency.

As compared to the first alternative embodiment with separate production units for the airflow and the water-flow regions, provision can be made in a second alternative embodiment for the air and water-flow regions to be constructed by bundling together individual, specially shaped, heat conduction plates. Accordingly, such a heat conduction plate features different segments wherein preferably at least two segments form divided areas of an airflow region and at least one segment a divided area of a water-flow region.

Accordingly, by bundling together several, especially identical, heat conductor plates, the resulting heat exchangers according to the invention are created with fully configured air and water-flow regions.

To this end, provision can be made for several perforations running perpendicular to the plate surface within the plate, which perforations are in alignment when several plates are bundled together, thereby forming water-flow channels and/or recesses into which separate tubes may be inserted. These tubes are heat conducting and may be bonded with the plates for example by pressing or other suitable methods.

Thus a single plate may for example feature a material of increased thickness with adjoining perforations, whereby the thicker material of several plates forms, when bundled together, the water-flow region and whereby in particular each increased thickness of the material is of a thickness matching the desired spacing of the plates. Such a plate may for example be produced by rolling out a profile flattened in its far ends, while retaining in the midsection of such flat profile the desired thickness of the material to accommodate the perforations. Provision can be made that in bundling together the individual heat conducting plates, the thicker materials lie tight against each other, so as to form the water-flow region in particular through the perforations.

In another embodiment, a plate may, for example, feature a corrugated bulge extending over its entire length and featuring recesses or perforations to accommodate tubes running perpendicular to the plates. Preferably, provision can be made for a heat conducting material to be insertable or inserted within such a corrugated bulge, so as to afford a better heat contact between the tubes to be inserted therein and the plates. For example, the heat conducting material may be formed as a heat conducting strap, which is or can be pressed into the bulge.

Much as in the previously mentioned first alternative involving several separate production units, the construction of the heat exchanger by bundling together several plates, in particular for example by a corrugated bulge or at least material of increased thickness within each plate, can also yield at least one separating surface to separate adjoining airflow regions from each other.

Accordingly, this can also accomplish that the air flowing in an airflow channel so constructed remains channeled from the inlet down to the outlet of the heat exchanger, not being able to escape in other directions. This results in an unimpeded flow stream with reduced flow resistance, along with the previously described special cleaning facility.

With both of the previously described alternatives, to which the invention is not limited, the water-flow channels arranged next to each other on one plane may be bundled together in parallel, and again separated after such bundling.

The possibility is thus created for the heat exchanger to feature several segments or regions wherein the water-flow is, or may be, separated into a variable number of divided waterways by bundling together a variable number of parallel water-flow channels. Thus, for example, in the first region of the heat exchanger the waterway may be subdivided into three divided waterways by bundling together three water-flow channels, and in another, for example adjoining region it may be subdivided into four divided waterways. Depending on specifications, this yields variable combination possibilities of bundling together of water-flow channels and/or subdividing them into divided waterways.

It is thereby possible to achieve in different regions of such a heat exchanger variable flow velocities while retaining constant the stream volume, inasmuch as by the subdivision and/or the reconstitution of the waterway with a variable number of water-flow channels, different effective inner cross-sections are also obtained by which the stream velocities within the particular region are affected.

The subdivision of the waterway into several divided waterways by the bundling together of several water-flow channels is not limited to specific areas of the heat exchanger. Provision may be made for the waterway at the inlet of the heat exchanger to be subdivided into a certain number of divided waterways or water-flow channels and for such subdivision to be preserved over the entire heat exchanger, and for the divided waterways at the outlet of the heat exchanger to be once again consolidated into one waterway. Accordingly, several parallel divided waterways created by the parallel consolidated water-flow channels traverse the heat exchanger, meandering for example from beginning to end.

According to the invention, the bundling together of different water-flow channels may be accomplished by various structural methods. For example, provision may be made for the water-flow channels to be realized by distribution pipes mounted externally on the heat exchanger. In this case, for example, the water-flow channels can project from the frontal sides of the heat exchanger and be connected by pipe elbows or transverse flow channels with connecting nozzles.

It is similarly feasible in an alternative embodiment for the water-flow channels to possess inner connectors. For example, such a type of connection can be chosen when the water-flow channels and in particular a heat conducting plate are constructed of adjoining rectangular tubes.

Generally speaking, it is possible in the frontal region of a heat exchanger to provide a removable and/or removed channel wall separating two adjoining water-flow channels, so as to make possible a simultaneous transfer of the water flow from a connector site into two or more water-flow channels. In such a case, the frontal ends of a heat exchanger according to the invention are constructed free of obstructing ductwork

In a preferred further embodiment, provision may be made for the waterway to surmount a water-flow channel provided in the heat exchanger, for example to insert in a channel so left unobstructed a measuring device, for example a temperature measuring gauge or the like.

### FIGURES

Sample executions of the heat exchangers according to the invention are illustrated in the following drawings which show:

FIGS. 1 and 2: a heat exchanger with airflow units and a water-flow unit mounted in-between, in the form of a heat conducting plate with channel-forming perforations arranged at right angles to the direction of the air;

FIG. 3: potential inner and outer interconnections of water-flow channels arranged next to each other;

FIGS. 4 to 10: additional possibilities for the construction of a heat exchanger according to the invention by bundling together identical, specially shaped heat conducting plates;

FIG. 11: a heat conducting plate constructed between airflow units by several rectangular tubes arranged adjacent to each other;

FIG. 12: the construction of a heat conducting plate by means of two divided plates on flanges arranged on inner sides facing each other for the construction of water-flow channels after bundling together of the divided plates;

FIG. 13: a heat exchanger made of heat conducting plates bundled together, each with punched-in perforations for the accommodation of tubes;

FIG. 14: a heat exchanger with a waterway subdivided into three divided waterways.

### DETAIL DESCRIPTION OF THE FIGURES

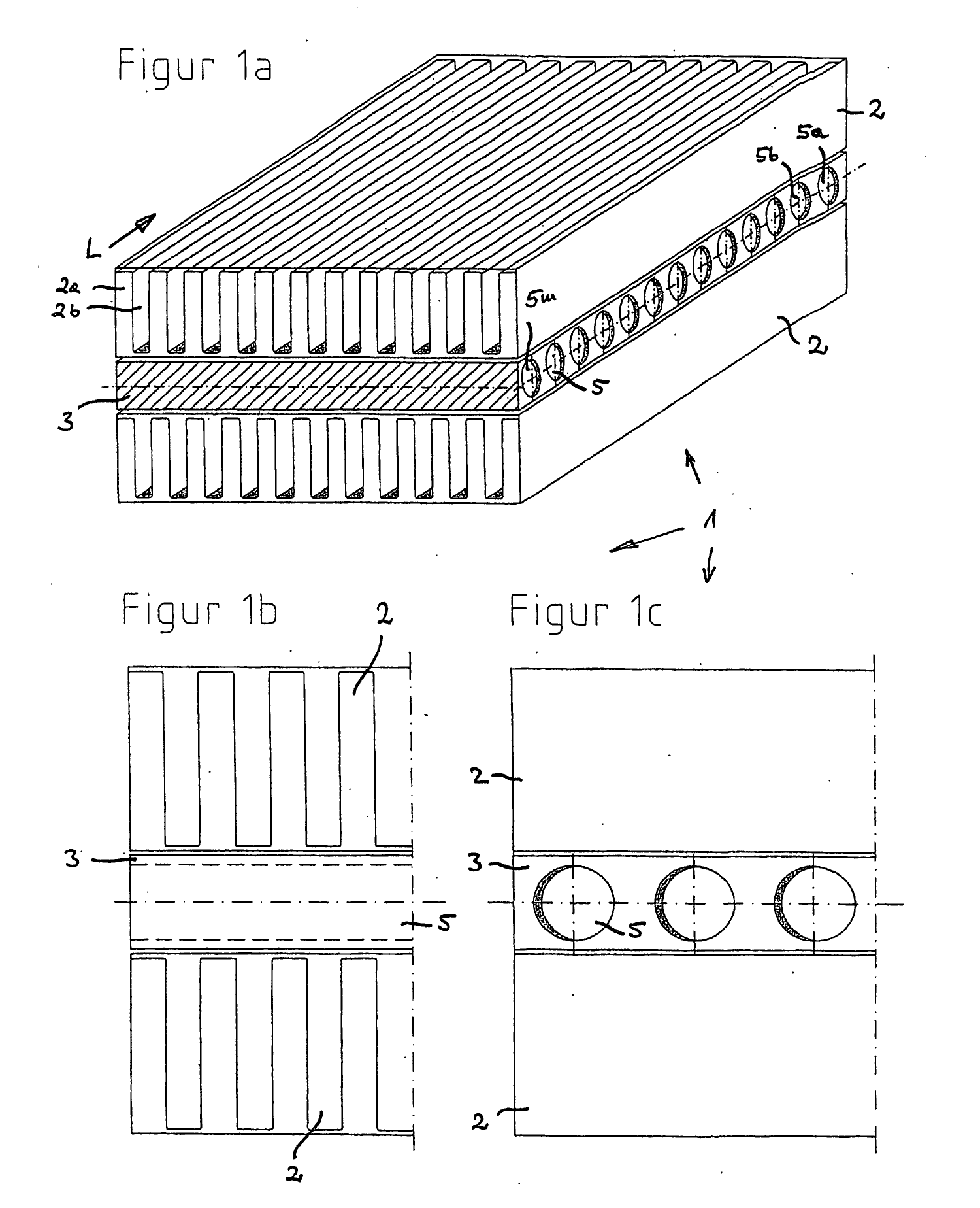

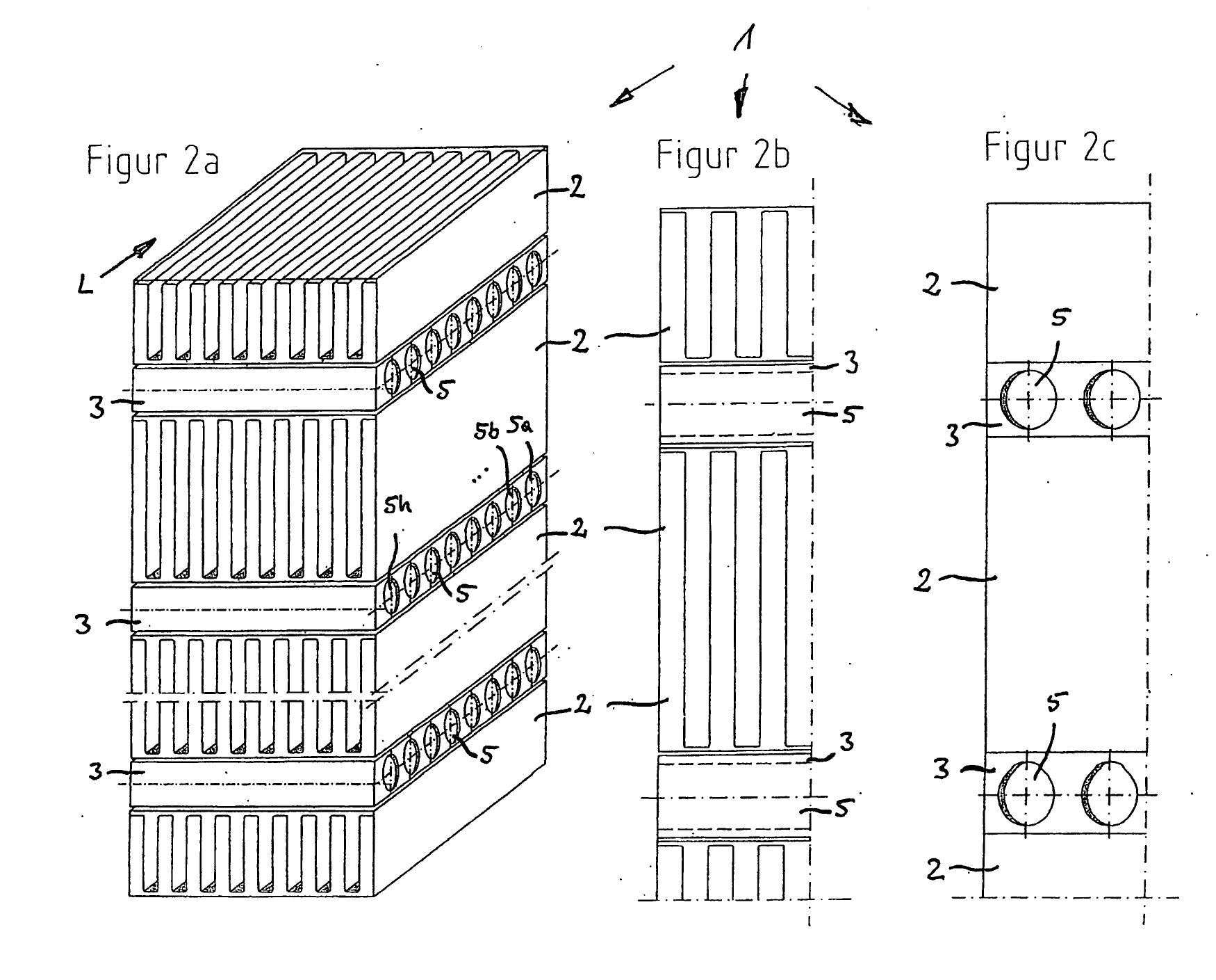

FIGS. 1 and 2 illustrate in different views the build-up of a heat exchanger 1 according to the invention, made of the corresponding production units, whereby in the illustration two airflow regions 2 are always separated from each other by a water-flow region 3 in the shape of a heat conducting plate 3. The air and water-flow regions built up as production units 2 and 3 are heat conducting and interconnected, so as to make possible an effective heat transfer between the air and the fluid medium. For the interconnection, the expert may choose a suitable method, such as for example grinding, soldering, bonding, welding, compressing, the use of heat conducting paste or other appropriate measures.

On its part, each heat conducting plate 3 features a number of perforations 5 running perpendicular to the direction of the airflow L, traversing completely the heat conducting plate 3 shown in FIGS. 1 and 2 as being of solid material and thereby forming a water-flow channel, so as to construct a heat exchanger along the cross-countercurrent principle by the parallel arrangement of several water channels 5 in sequence.

As shown in FIG. 1a and FIG. 2a, water flows for example perpendicular and counter to the air direction L from the water-flow channel 5a through all the other water-flow channels 5 to the last water-flow channel 5m. A suitable hookup ensures here that the water flowing into the water-flow channel 5a, for example on the right side of the heat exchanger 1, can overflow into the pre-positioned water-flow channel 5b on the back side not illustrated here. The water can thereby flow meandering into the heat exchanger.

Thanks to the configuration of the airflow units and the heat conducting plate 3 arranged between the two airflow units 2, there is complete separation of the airflows in the two airflow regions 2 as well as separation of the individual divided airflows within the airflow channels 2a, 2b etc. This yields the previously described special cleaning facility of such a heat exchanger and, based on the unimpeded flow of air, an especially limited loss of pressure with its noticeably beneficial energetic effect.

As compared to FIG. 1, FIG. 2 illustrates in addition that several of the heat exchanger modules illustrated in FIG. 1, each consisting of two airflow regions and the water-flow region arranged between them, may be bundled together into a global heat exchanger. To preserve the water equivalent ratio, provision can be made here for the airflow region positioned between two water-flow regions and/or heat conducting plates 3 to possess double the structural height of the airflow region 2, which merely adjoins on one side a water-flow region and/or heat conducting plate 3.

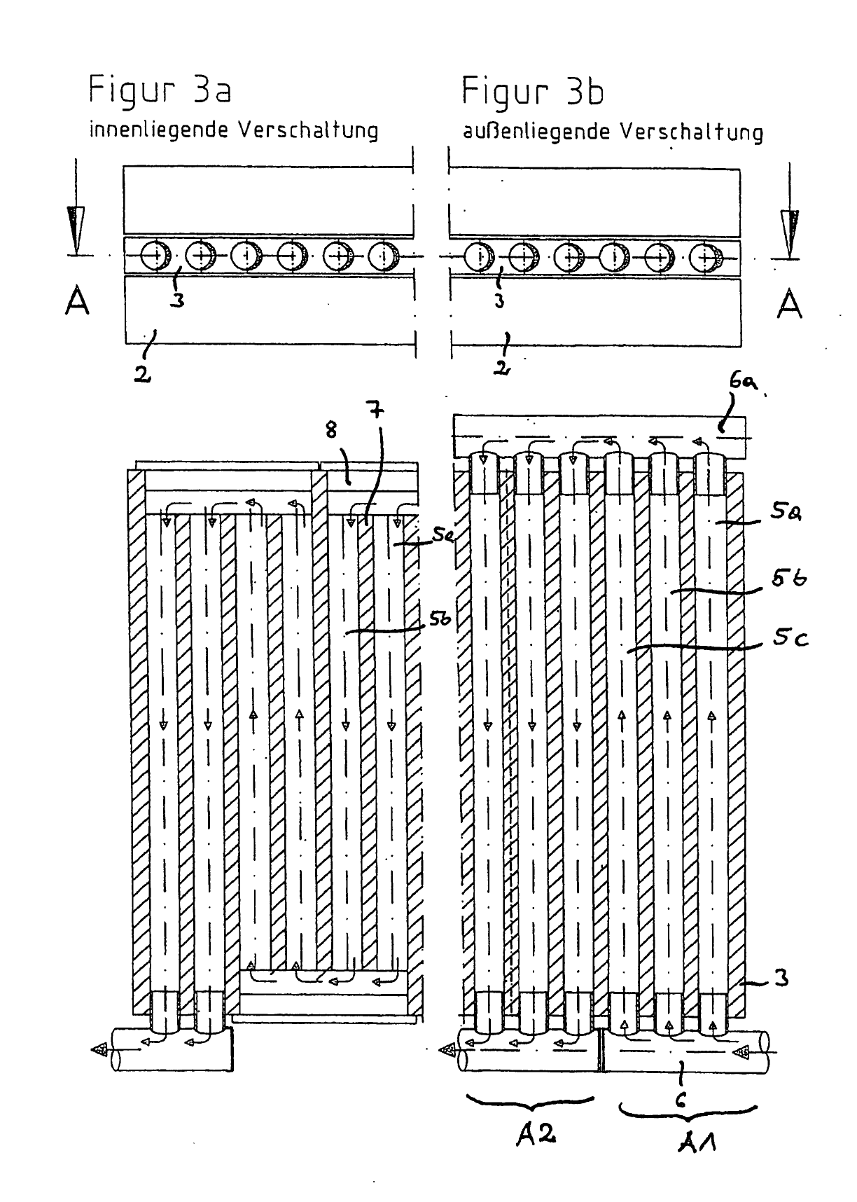

FIG. 3 illustrates different possibilities of bundling together adjoining water-flow channels constructed in a heat conducting plate 3, that is to say, subdividing the waterway into divided waterways in order to adjust the water equivalent ratio and/or achieve the desired flow velocity.

Thus, as shown in FIG. 3b, the three water-flow channels 5a, b and c are technically connected in parallel into a waterway, wherefore the waterway from distribution pipe 6 in Segment A1 is subdivided into the three divided waterways of the water-flow channels 5a, b, c and after running perpendicularly through the heat exchanger is once again consolidated into the counter-opposed collecting pipe 6a, in order to execute forthwith a new subdivision in Segment A2 into the three adjoining water-flow channels. Bundled together, the water in the water-flow channels 5a, b and c runs in the same direction, transverse to the direction of the airflow.

The bundling together and the subdivision of the waterway is accomplished here by a connection provided on the outside of the heat exchanger in the shape of a transverse distribution pipe 6/6a featuring nozzles for the intake of water into the heat conducting plate 3 and/or the outlet.

By this consolidation for example of three water-flow channels 5a, b and c it is possible to achieve, given a steady flow volume, a flow velocity reduced by a factor of 3, as compared to a single water-flow channel. Thus, even with a steady velocity of the water-flow, the volume of air may be augmented by a factor of 3. Other factors are correspondingly feasible at will.

As a further alternative, FIG. 3 illustrates an interior connection of the individual water-flow channels, whereby in this instance only two water-flow channels 5a and 5b are technically interconnected into one waterway. The interconnection is established here by removing the material 7 between the two water-flow channels 5a and 5b in the frontal region of a heat exchanger and closing the resultant gap in the heat conducting plate 3 with a stopper 8. This ensures that the water inflow is simultaneously subdivided into two water-flow channels 5a and b, so that these two water-flow channels build up a waterway through the heat exchanger.

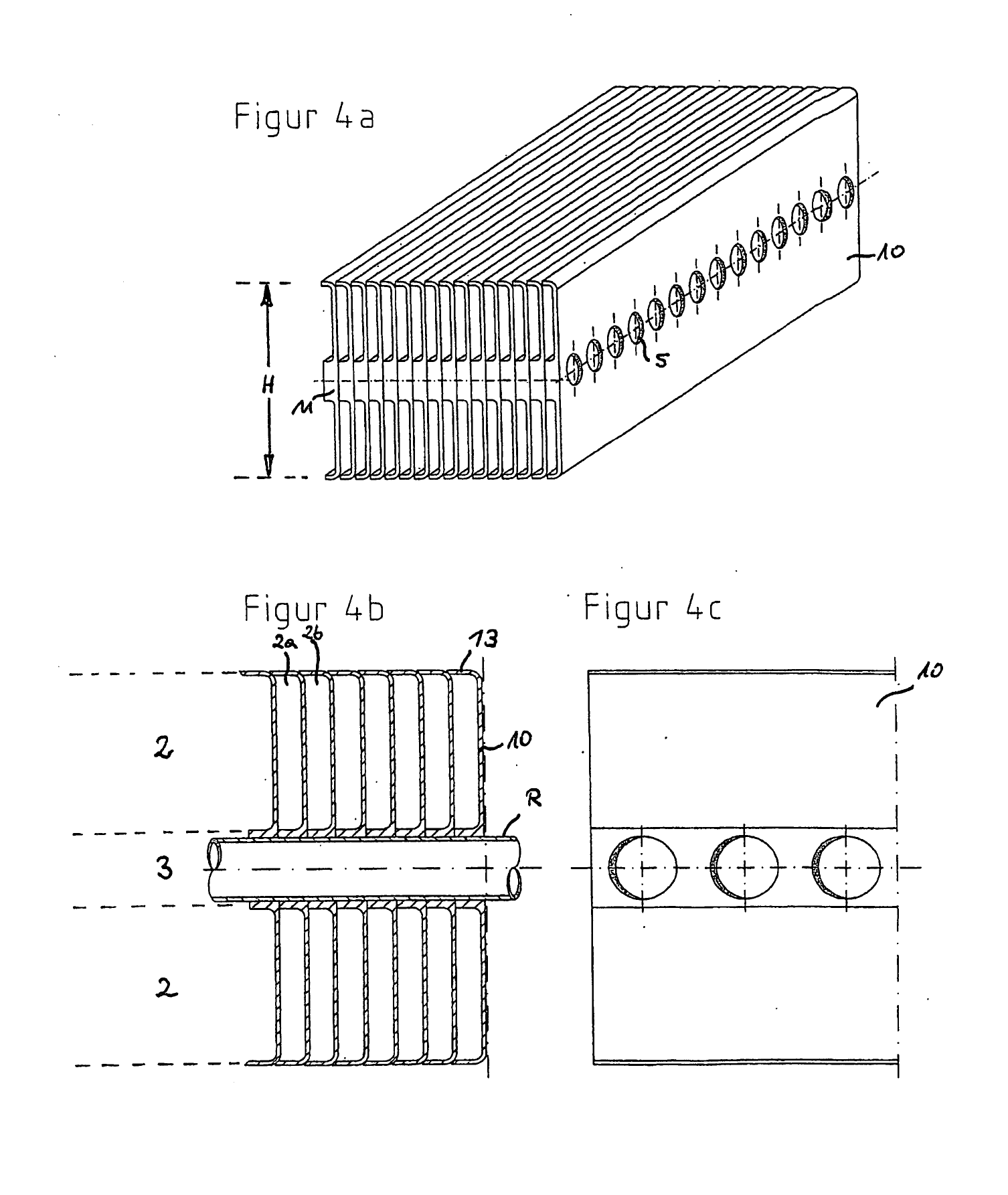

FIG. 4 illustrates in several different views that the air- and water-flow regions of a heat exchanger according to the invention can be built up by bundling together individual, in particular specially shaped heat conducting plates 10, whereby each heat conducting plate 10, or at least a number of such plates are identical in construction, featuring within the height H of the plate thicker material 11 extending over the entire plate 10. In the instant case, the thicker material 11 is built up in the approximate center of the plate 10.

Perpendicular to the surface of a plate 10, there are several perforations 5 arranged the one next to the other, extending centrally through the thickening in the material 11, and forming, after several plates 10 are bundled together, the waterway perpendicular to the direction of the airflow in the heat exchanger.

In the illustrated structure, a plate 10 features partial segments of air and water-flow regions, resulting from the consolidation of several plates, whereby the area surrounding the thicker portion of the material 11 forms the later water-flow region 3, and a portion of the airflow region 2, as illustrated in the upper and lower areas of FIG. 4.

After bundling together individual plates, a water-flow channel is formed by the aligned arrangement of different perforations 5, wherein either a supplemental duct R is inserted or the same is created by the compacting superposition of the material thicknesses 11.

Manifestly, in this construction as well the airflow region 2 is completely separate from a water-flow region W, so as to preclude the air overflowing from one airflow region into another. Also within an airflow region 2 there are created in particular by the material thickening 11 and by the upper beveling of each plate separate airflow channels 2a, 2b etc., so as to achieve the previously described cleaning facility and minimization of pressure loss.

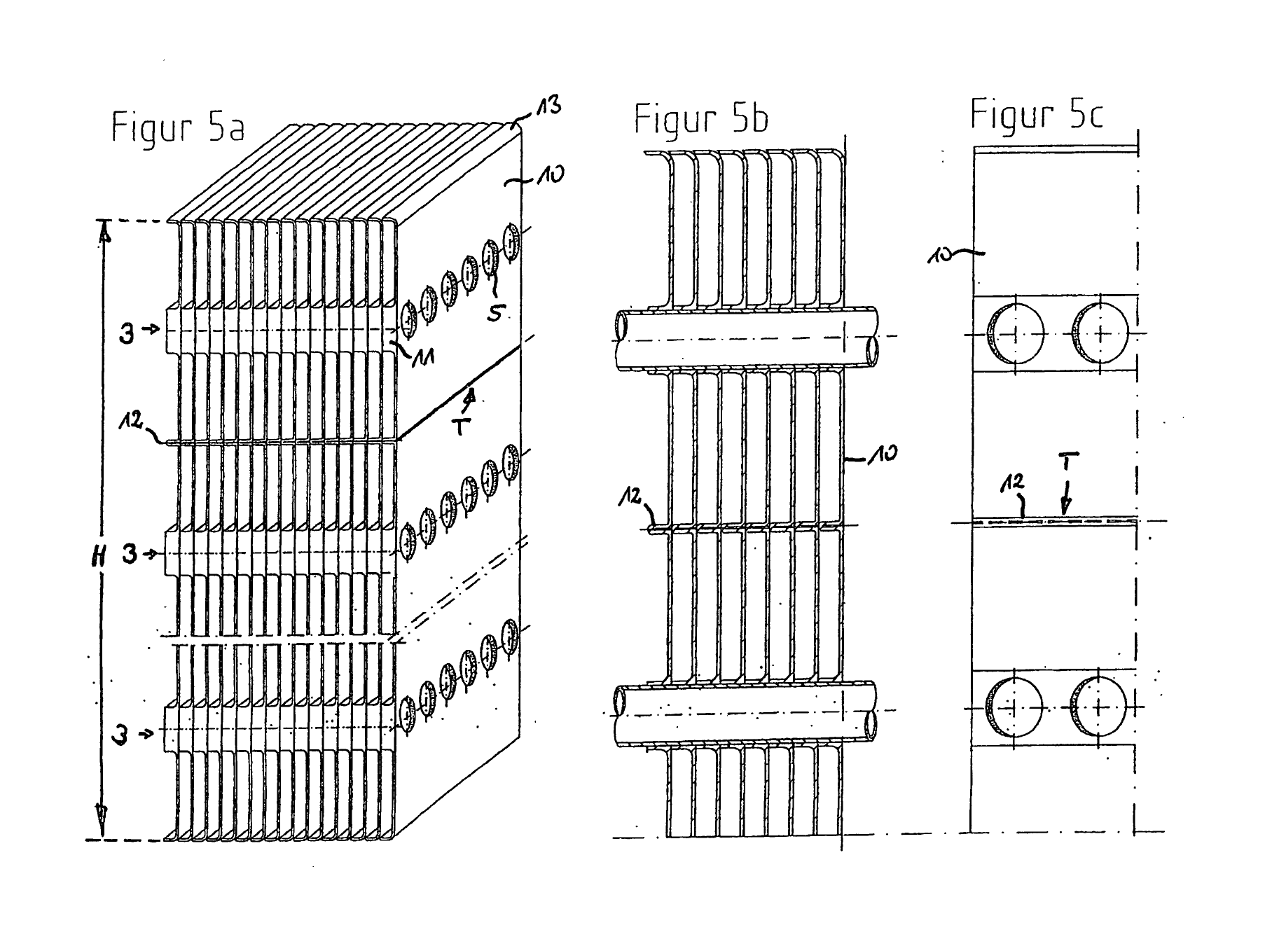

As compared to FIG. 4, the FIG. 5 illustrates a substantially identical embodiment, whereby however a single plate exhibits a substantially greater height H and within the height of the plate provision is made for several thickenings of the material in order to form along with several airflow regions also several water-flow regions, always preferably arranged in parallel planes.

Additionally, provision can be made that between two water-flow regions 3 within an airflow region 2 each plate features a bulge, a projection, a corrugation or other structure 12, so that in bundling together several plates 10, these structures 12, which are always lying the one next to the other, effectively create a separation surface T, subdividing once again the individual airflow channels 2a, 2b etc. of an airflow region.

This makes it possible to preserve the previously described ease of cleaning construction of a heat exchanger even in airflow regions of greater structural height.

FIG. 5 also shows at the outer extremities of each plate 10 an optional beveling 13, so that by means of such a bevel a sealed airflow channel 2a, 2b etc. is also created on the outer side of the heat exchanger.

In the previously described sample embodiment, the thickness of the material thickening 11 within the plate is chosen in such a way that bundling together the individual plates 10 creates a plate spacing matching the thickness of the material thickening 11.

Accordingly, thanks to the construction of each plate, the bundling together ensures the periodic build-up of a heat exchanger according to the invention.

The thicker material illustrated in FIGS. 4 and 5, limited to just one side of the plate, may be produced by constructing a plate as an extruded profile or even as a rolled out flat profile featuring a bulge, corrugation or projection.

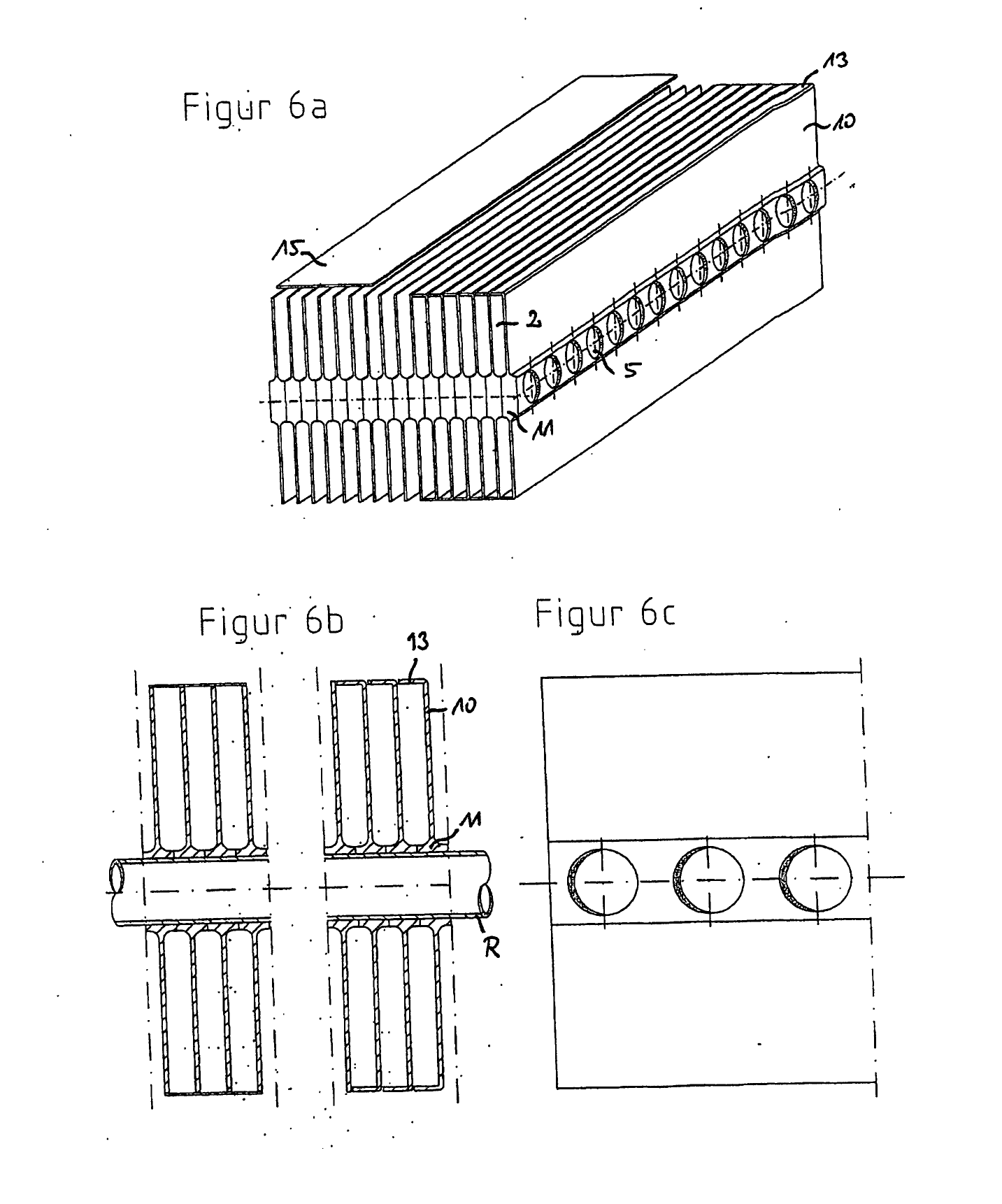

FIG. 6 shows an alternative embodiment of a heat exchanger produced by bundling together several identical plates, whereby contrary to FIG. 4, the plate 10 shows a material thickening 11 extending along both surfaces of a plate 10. As in FIG. 4, each material thickening 11 within the plate and extending over its length features several perforations arranged next to each other which, when joined in alignment and if need be with a compressed tube R inserted therein, form a portion of the overall waterway.

The illustration shows that a modular heat exchanger block may feature outwardly sealed airflow channels 2 in that the corresponding plates 10 are built with the upper side shaped as a bevel 13 whose end lies upon the upper surface of an adjacent plate 10. It is similarly feasible to seal a non-beveled plate 10 on the upper side by means of a superimposed separator plate 15, thereby constructing the different individual airflow channels 2. Such separator plates 15 may also be inserted between individual stacked heat exchanger modules, as illustrated in FIG. 6, to achieve separation of the airflow channels 2.

In contrast to the structures shown in FIGS. 4 and 5, with the thicker material featured on one side, the plate 10 constructed with thicker material 11 on both sides, as shown in FIG. 6, has the advantage that the heat conduction through the plate 10 in the water-flow channel 5 or the tube R inserted therein is improved by symmetrical heat conduction paths, wherefore the embodiment of FIG. 6 is to be deemed preferable to the one illustrated in FIG. 5.

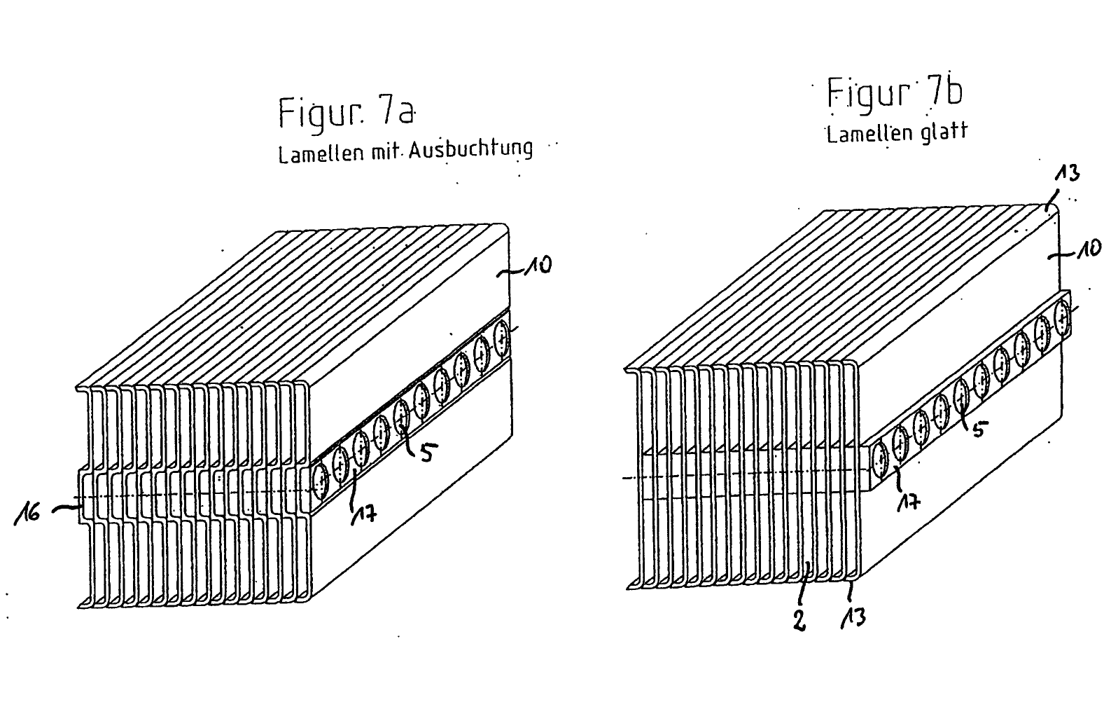

FIG. 7 shows a further alternative embodiment of a heat exchanger constructed of several identical plates, whereby a plate 10 exhibits for example a corrugated bulge 16 extending over the entire length of a plate and the subsequent water-flow region formed after bundling. Into such bulge 16 a heat conducting material, as for example a heat conducting strap 17 may be inserted, which strap is joined by cementing, compressing or similar heat-conducting measures with the plate 10, featuring perforations 5 which form the subsequent waterway perpendicular to the plate direction.

As compared to FIG. 7a, the FIG. 7b shows a very simple formation of identical plates 10, completely flat on their upper surface and merely featuring beveled upper and lower ends to seal the individual airflow channels 2. In order to form a sealed water-flow region and distance the individual plates, a flat profile or heat conducting strap 17 is inserted between the individual plates 10, again featuring a number of adjoining perforations aligned with the corresponding perforations in each plate 10. By bundling together a number of identical heat conducting plates and heat conducting straps 17, an airflow region and a water-flow region are created here, as described in FIG. 4b.

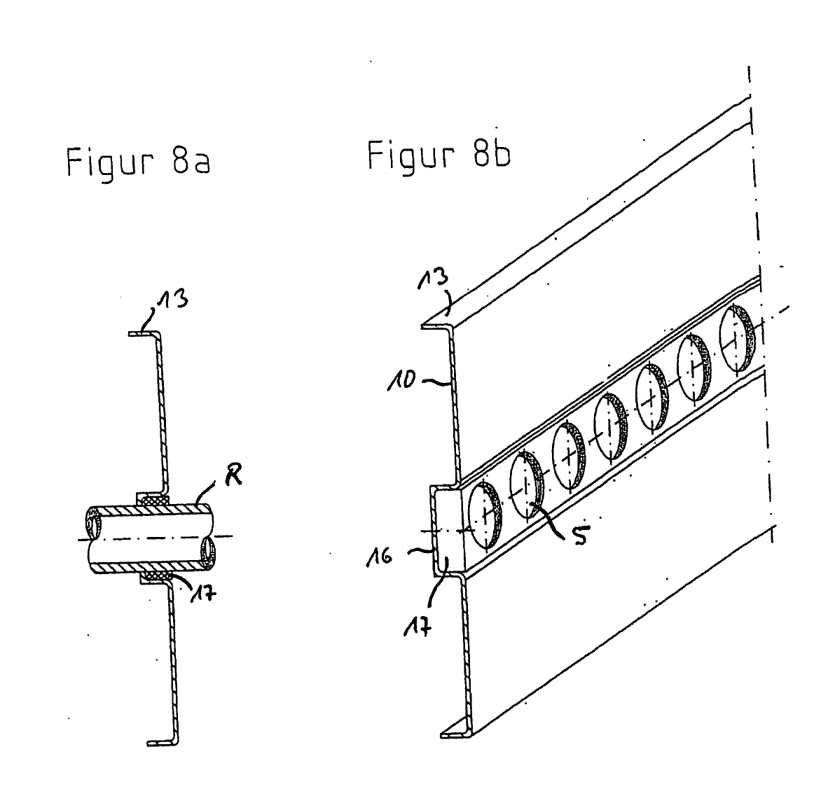

FIGS. 8a and 8b show close-up detailed illustrations of a single plate 10 according to FIG. 7a, disclosing in the corrugated bulge 16 the inserted heat conducting strap 17 featuring a number of perforations 5 arranged next to each other. As shown on the left side of FIG. 8a, it is possible to insert a further tube R within the individual perforations 5, linked with the heat conducting strap 17 for example by heat conductive compressing. On the top and bottom of the illustrated plate 10, beveling 13 is shown, whereby the width of a bevel 13 matches the depth of the bulge 16, so that this dimension represents the spacing between the individual plates 10.

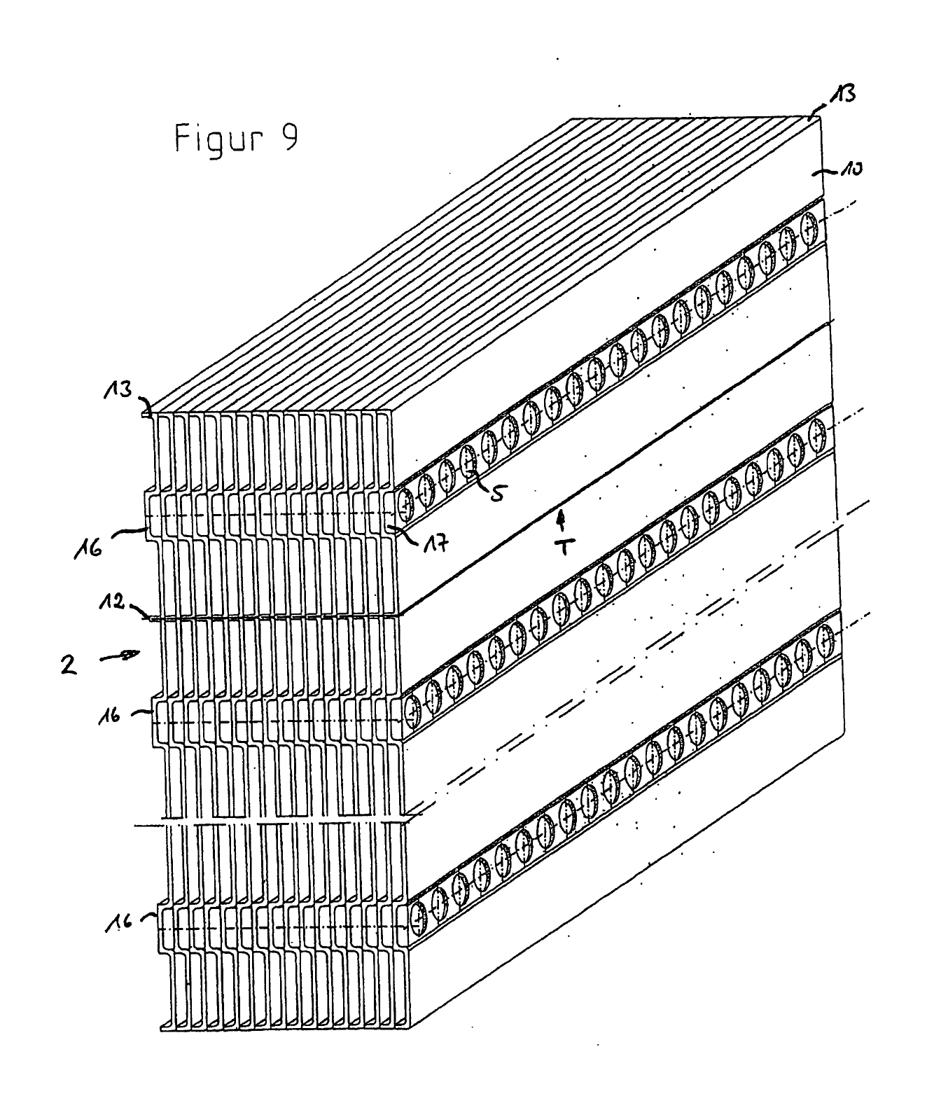

Consistent with FIG. 5, the FIG. 9 shows a modular heat exchanger unit of greater height, with inserted heat conducting plates as previously described in FIGS. 7 and 8.

Again it will be seen that inside a plate provision is made for several corrugated bulges 16, with a heat conducting strap 17 inserted therein. Inside an airflow region 2, each plate 10 exhibits the previously described construction 12, forming a further separator surface T within the airflow region 2 when the individual plates are bundled together.

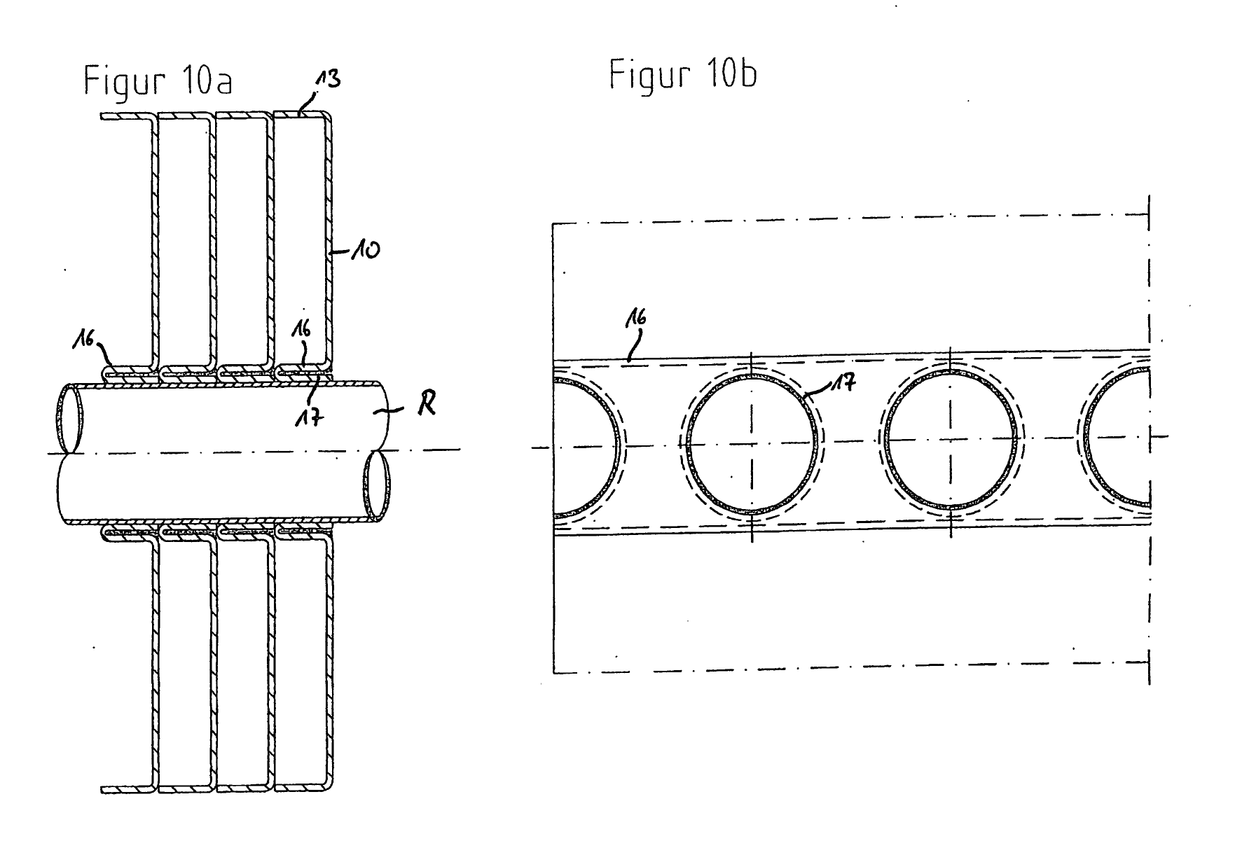

FIG. 10 illustrates a special construction of individual plates 1 0,whereby over the entire plate length, much as previously described in FIGS. 7, 8 and 9, provision is made for a bulge 16, whereby within such bulge 16 there are punched-in circular counter-recesses 17, featuring a circular inner cross-section to accommodate a tube R.

By means of the counter-recesses 17, a spring-like elasticity is afforded in connecting the water-conducting tube R with the plate 10. As previously described, each for example corrugated bulge 16 within a plate has a depth matching the desired spacing of the individual plates 10 to each other, which is also the case with the upper and lower bevel 13 of each plate.

Thanks to the bulge 16 extending over the entire length of the plate, an effective separator surface is again formed between the individual airflow regions and/or the individual airflow channels, thereby precluding an overflow of air from one into another airflow region and achieving the previously described cleaning facility and limited airflow resistance.

Compared to FIGS. 1 and 2, the FIG. 10 shows an alternative embodiment in which the airflow and the water-flow regions are again constructed as separate production units.

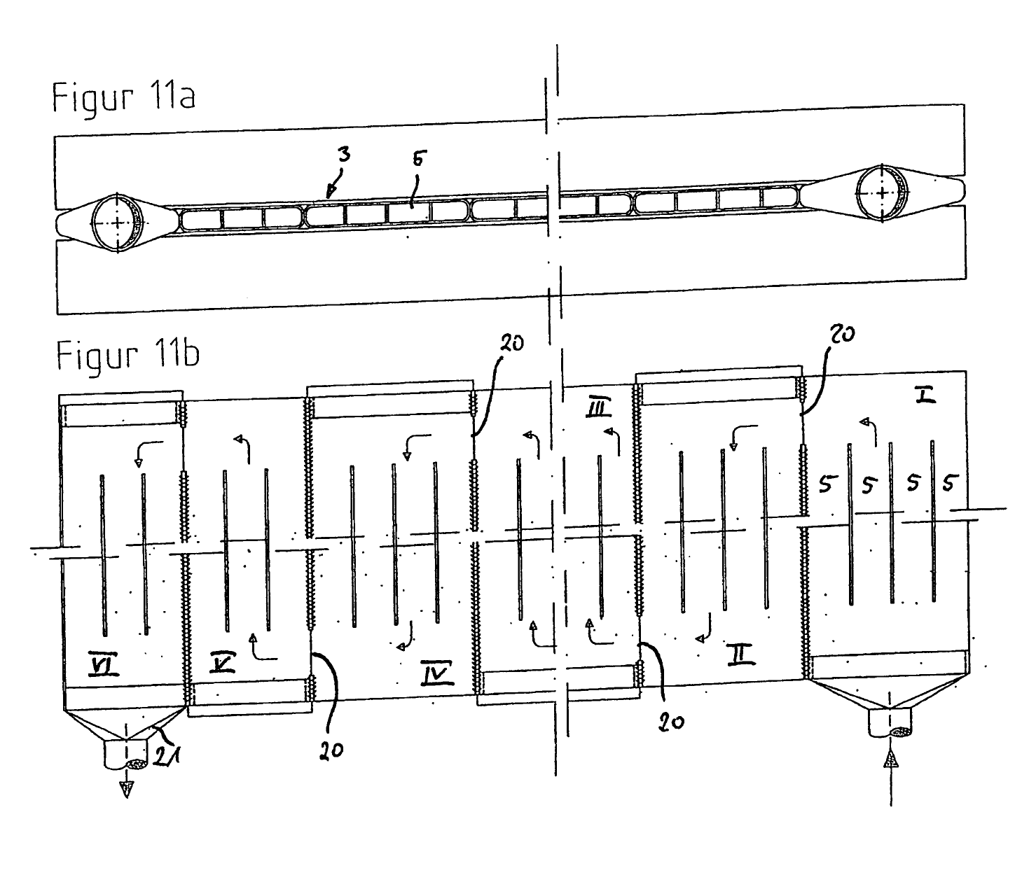

In FIG. 11, the heat conducting plate 3 is formed by several rectangular tubes 5 arranged next to each other, featuring always the same structural height.

Provision may be made here for several rectangular tubes 5 to be bundled together in units of several, for example three or four rectangular tubes or for a rectangular tube to feature additional subdividing inner channel walls.

The individual rectangular tubes or tube units are suitably interconnected for example by welding, whereby in this instance bundling together several rectangular tubes 5 is accomplished by an inner connection of the individual tubes. To this end, it is possible to remove segmentally in the frontal area of a heat exchanger the separator channel walls between adjoining rectangular tubes, as exemplified in location 20, so that here the water, for example from an initial waterway I configured of four rectangular tubes 5, flows over directly into a second waterway II.

In this and in all other structures, provision may be made for a variable number of bundled water-flow channels 5 within the different regions of a heat exchanger, as illustrated here, for example, in the waterways IV and V. The waterway IV is composed of a total of four rectangular tubes, whereas waterway V consists of merely three rectangular tubes, so that in these two areas of the heat exchanger different flow velocities prevail for one and the same flow volume.

This permits setting variable segmental flow velocities within a heat exchanger, by bundling together different numbers of water-flow channels, or for example rectangular tubes here.

The water connection to the entire heat exchanger circuit can be achieved here by an adapter element converting the longitudinal rectangular cross-section into a circular cross-section for distribution to the customary tubes.

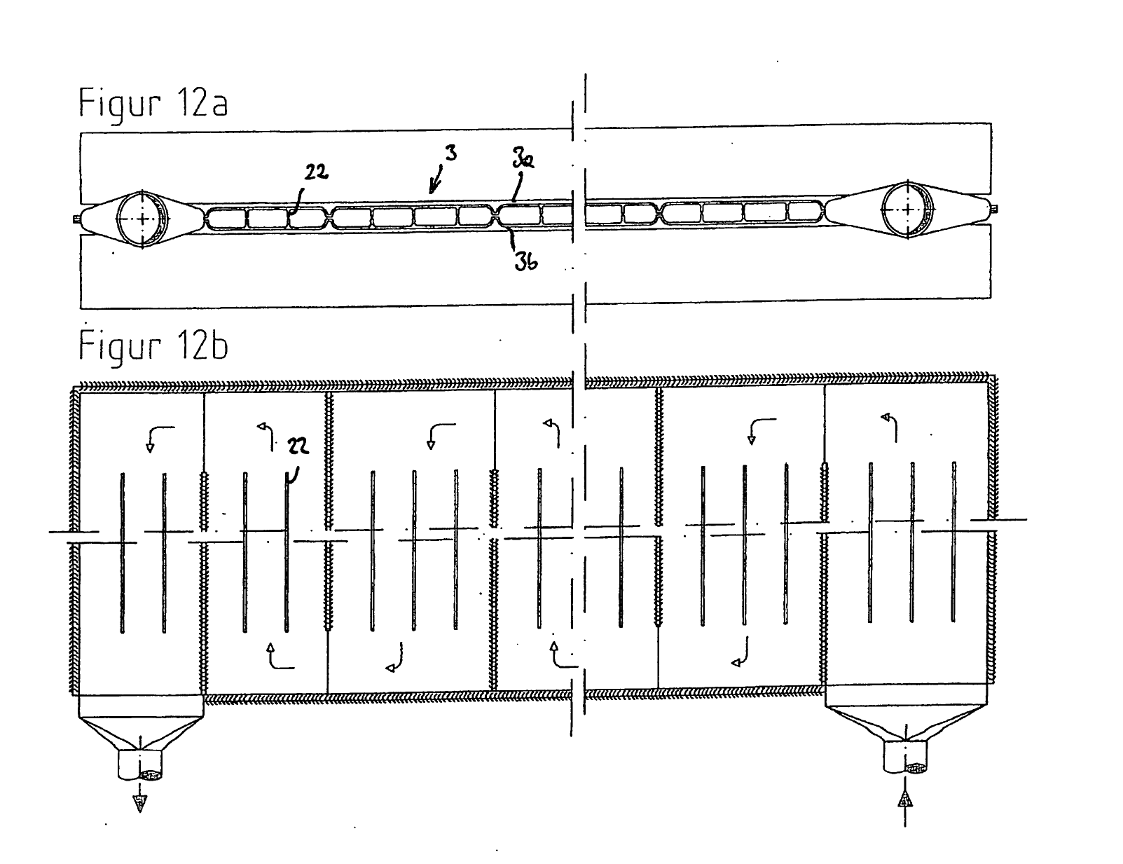

FIG. 12 shows a further embodiment wherein the heat conducting plate 3 is configured by an upper dividing plate 3a and a lower dividing plate 3b. Each of these dividing plates features on the facing sides at least one flange 22 lying opposite a corresponding flange on the other dividing plate, so that by bundling together the upper and the lower dividing plate, flow channels are created within the heat conducting plate 3. The plates can be joined by conventional means, such as soldering, welding, cementing, compressing etc.

Further build-up is essentially as already described in FIG. 11.

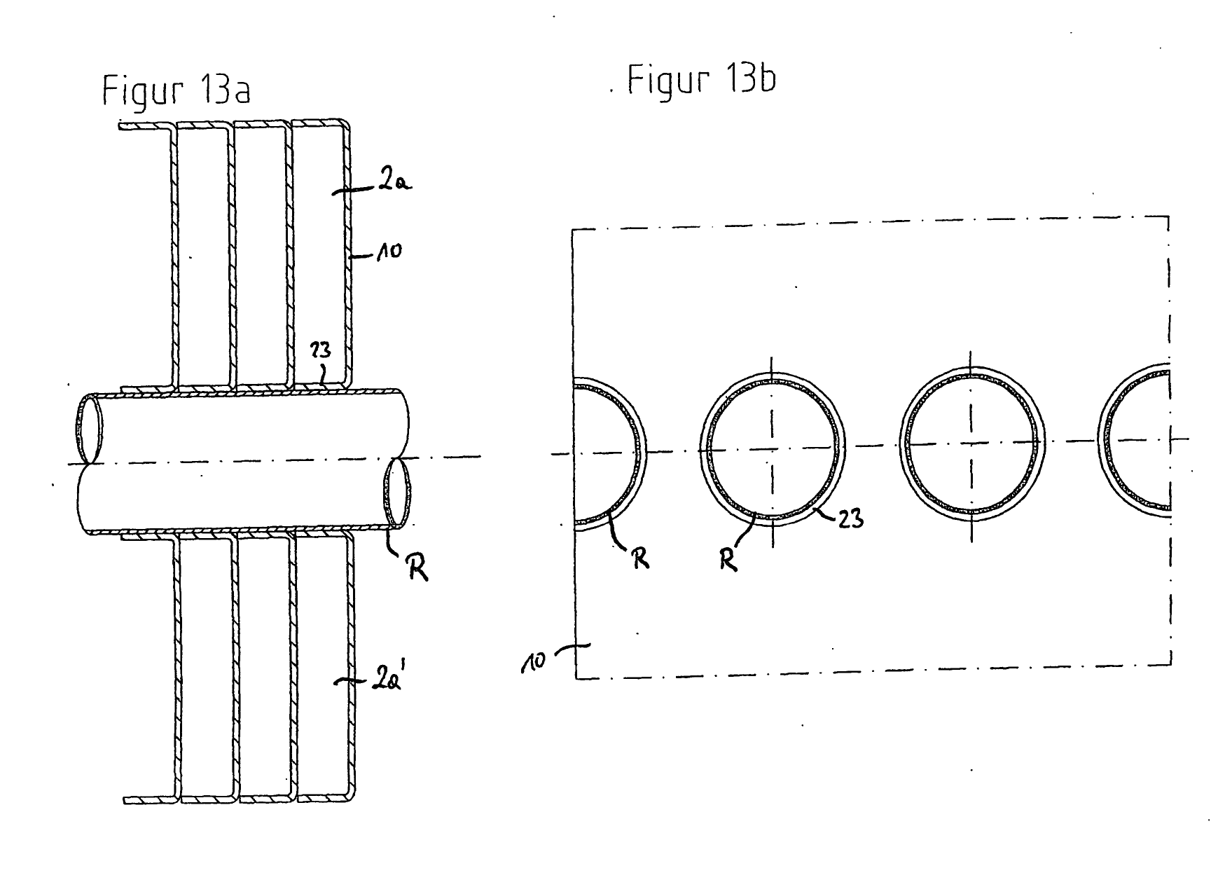

FIG. 13 shows another alternative heat exchanger, made up of several identical heat conducting plates 10. The heat conducting plates 10 illustrated here show a very simple structure with merely circular recesses 23, produced for example by punching. These recesses 23 create a tubular segment facing away from the surface of the plate, wherein it is possible to press in a heat-conducting tube R, forming a good inner heat conducting contact between the tube R and the plate by way of the recess 23.

Recess 23 is inserted in the level surface of the plate 10, affording basically the possibility of the air transfer between two tubes R from the upper airflow channel 2a into a lower airflow channel 2a′. Although this embodiment represents a structure involving greater loss of pressure within the airflow regions, it nevertheless affords, consistent with the basic principles of the invention, a very simple manner of interconnecting on one level several adjoining tubes for the adjustment of the water equivalent ratio and the flow velocity.

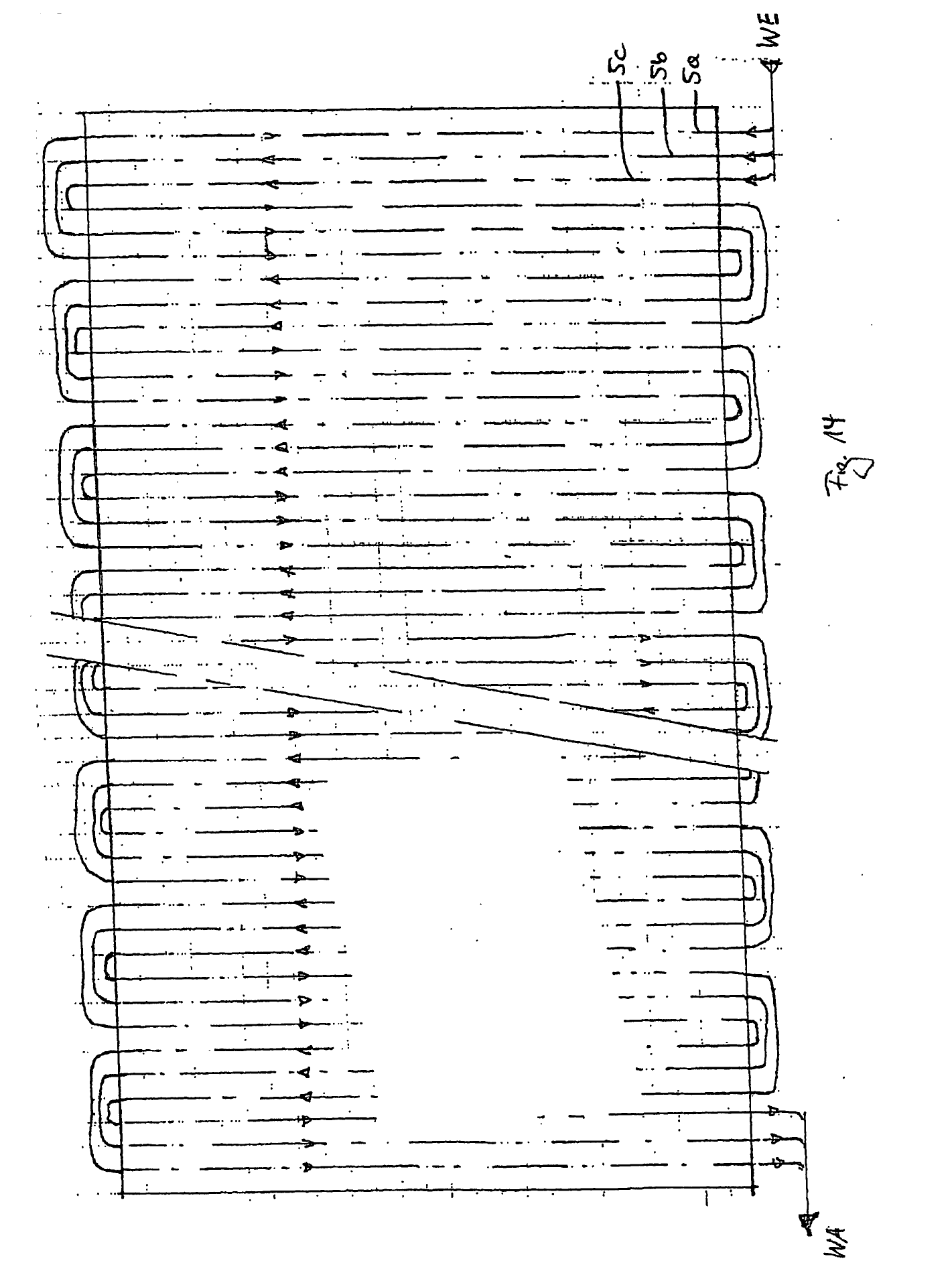

FIG. 14 shows the sketch of an embodiment wherein the waterway is divided through a heat exchanger at the water intake WE into three divided waterways running through the water-flow channels 5a, 5b and 5c. While retaining this subdivision into three divided waterways, the water is channeled meandering through the entire heat exchanger until it is ultimately once again consolidated into one waterway at the water outlet WA. Accordingly, the subdivision into several waterways does not take place in one single region or segment of the heat exchanger, but throughout the entire heat exchanger.

By reason of the adjacent arrangement of the flow channels 5 upon one plane within the heat exchanger, it is possible, while retaining the once-chosen subdivision, to subdivide the constant flow volume of water into several divided waterways. Depending on need, it is also possible here to select different numbers of divided waterways, or to change the subdivision or reconstitution by regions.

The special essential principle of the invention to permit changing the flow speed and the water equivalent ratio within the illustrated heat exchanger according to the invention, consistent with all the alternatives, rests in a specially preferred embodiment on the fact that contrary to conventional heat exchangers, use is made of water-flow channels of substantially diminished flow cross-sections. Thus, as a matter of prior art, it is customary to employ tubes with inner diameters of 8 to 15 mm for the waterways.

In the invention described here, the preferred cross-section of flow channels is 10 to 50% of the connecting cross-section of a waterway, whereby in particular the distance between the inner channel walls of one water-flow channel to the next is preferably chosen smaller than the inner diameter of a tube and/or the width of a channel. Thus, the connecting cross-section of a waterway is subdivided over many, especially as many flow channels of more limited cross-section as possible, whereby in particular the sum of such smaller cross-sections matches approximately the connecting cross-section.

The result is a number of very tightly arranged small flow channels on one plane, so that one single water-flow channel of such a reduced flow cross-section may achieve an adequate flow velocity even in the presence of low flow volumes.

By bundling together several of these adjoining water-flow channels, it is possible in the presence of an increased total flow volume, for example in a global heat exchanger plant of larger dimensions, to reduce the consolidated divided waterways, thereby presetting at all times the optimum by a more or less large number of interconnected channels.

The invented heat exchanger therefore possesses the special advantage that it may be available in stock in standardized modular units and that matching the given outside conditions, such as airflow, water-flow and structural dimensions, can in a simple manner be adjusted to the resulting water equivalent ratio and the requisite flow velocities by merely the more or less intensive bundling together of the waterways.

Accordingly, the heat exchanger according to the invention is very economical, easy to maintain and energy-saving by reason of the substantially unobstructed airways constructed as previously described and affording the mentioned cleaning facility by their separation.

1-13. (canceled)

14. A countercurrent laminar heat exchanger for the heat exchange between gaseous and liquid media in modular or block modular construction comprising:
two airflow regions each having an air inlet and an air outlet;
a modular water-flow region disposed between the two airflow regions comprising a plurality of water-flow channels, wherein the water-flow channels are arranged on one level from the air intake to the air outlet and the water-flow region is subdivided through the heat exchanger in at least one segment/area by bundling together several of the water-flow channels into two or more parallel divided waterways thereby allowing for the adjustment to a desired water equivalent ratio.

15. The heat exchanger according to claim 14 wherein by subdividing the water-flow region into several parallel divided waterways different flow velocities may be set.

16. The heat exchanger according to claim 14 wherein the each airflow region and the modular water-flow region are separate components.

17. The heat exchanger according to claim 14 wherein the modular water-flow region is constructed in the shape of a heat conductor plate that is formed from a plurality of parallel rectangular ducts arranged next to each other with water-flow channels arranged therein, whereby the heat conductor plate separates the airflow areas from each other, wherein the heat conductor plate, by reason of its shape, forms water-flow regions when bundled together with other heat conductor plates.

18. The heat exchanger according to claim 14 wherein the modular water-flow region is constructed in the shape of a heat conductor plate that is constructed of at least two interconnected divided plates with water-flow channels arranged therein, whereby the heat conductor plate separates the airflow areas from each other and the heat conductor plate, by reason of its shape, forms water-flow regions when bundled together with other heat conductor plates.

19. The heat exchanger according to claim 17 wherein the rectangular ducts, while of identical height, feature different widths and thereby different cross-sections.

20. The heat exchanger according to claim 14 wherein the airflow region and the water-flow region are formed by bundling together individual heat conducting plates and the bundling forms at least one separating surface to separate adjoining airflow areas from each other.

21. The heat exchanger according to claim 14 wherein the airflow region and the water-flow region are formed by bundling individual heat conducting plates and each heat conducting plate features at least one thicker material with adjacent perforations, whereby the thickened material of several plates forms the water-flow area after bundling together.

22. The heat exchanger according to claim 21 wherein the thickened material extends on both sides of the surface of the heat conducting plate.

23. The heat exchanger according to claim 14 wherein the airflow region and the water flow region are formed by the bundling together individual heat conductor plates and the heat conducting plate features a corrugated bulge within which a heat conducting material is inserted in the bulge.

24. The heat exchanger according to claim 23 wherein the heat conducting material comprises a heat conducting strap which is connected with the heat conductor plate, featuring perforations forming the waterway perpendicular to the direction of the heat conductor plate.

25. The heat exchanger according to claim 14 wherein the airflow region and water-flow region are formed by the bundling of individual heat conducting plates and each plate features a corrugated bulge in which are punched-in counter-recesses featuring a circular inner cross-section to accommodate a duct.

26. The heat exchanger according to claim 14 wherein the heat exchanger features several segments/areas wherein the waterway is subdivided by bundling a variable number of parallel water-flow channels into a variable number of the divided waterways.

27. The heat exchanger according to claim 14 wherein the water-flow channels feature a cross-section amounting to 10% up to 50% of the connecting cross-section of at least one of the waterways.

28. Heat exchanger according to claim 14 wherein the distance between the inner channel walls of one water-flow channel to the next is smaller than the inner diameter or the width of a water-flow channel.

29. The heat exchanger according claim 14 wherein the waterway through the heat exchanger is subdivided in at least one divided area of the heat exchanger into several divided waterways, in particular in several water-flow channels arranged in parallel one after another on one plane, in the direction of the air flow.

30. The heat exchanger according to claim 29 wherein different flow velocities are preset by region through the subdivision and/or recombination of a different number of water-flow channels.
